(19) United States
(12) Patent Application Publication
(10) Pub. No.: US 2022/0126396 A1
(43) Pub. Date: Apr. 28, 2022

(54) OPTICAL APPARATUS FOR THE LASER WELDING OF A WORKPIECE, WITH A PLURALITY OF PARTIAL BEAMS HAVING A CORE ZONE AND A RING ZONE IN THE BEAM PROFILE

(71) Applicant: TRUMPF Laser- und Systemtechnik GmbH, Ditzingen (DE)

(72) Inventors: Daniel Flamm, Ludwigsburg (DE); Patrick Haug, Gerlingen (DE); Tim Hesse, Ditzingen (DE)

(21) Appl. No.: 17/569,549

(22) Filed: Jan. 6, 2022

Related U.S. Application Data
(63) Continuation of application No. PCT/EP2020/069130, filed on Jul. 7, 2020.

(30) Foreign Application Priority Data
Jul. 8, 2019 (DE) 10 2019 210 019.8

(51) Int. Cl. B23K 26/067; B23K 26/064; B23K 26/24

(52) U.S. Cl. CPC B23K 26/067; B23K 26/24; B23K 26/064

(57) ABSTRACT

A laser welding optical apparatus includes: a laser beam source; a collimation optical unit collimating the provided laser beam; a beam splitter splitting the collimated laser beam into partial beams, the beam splitter having a first setting facility, which variably sets the splitting of the collimated laser; and a focusing optical unit focusing the partial beams onto the welding workpiece The laser beam source has a multiclad fiber having a core and ring fiber, and a second setting facility, which variably splits an input laser beam at an end of the multiclad fiber between the core and ring fiber. A second end of the multiclad fiber provides the laser beam for the collimation optical unit. The beam splitter splits the collimated laser beam among two leading and trailing partial beams. The first setting facility sets the energy distribution between the leading and the trailing partial beams.

### CROSS REFERENCE TO RELATED APPLICATIONS

This application is a continuation of International Application No. PCT/EP2020/069130 (WO 2021/005061 A1), filed on Jul. 7, 2020, and claims benefit to German Patent Application No. DE 10 2019 210 019.8, filed on Jul. 8, 2019. The aforementioned applications are hereby incorporated by reference herein.

### FIELD

The present invention relates to an optical apparatus for the laser welding of a workpiece, with a plurality of partial beams having a core zone and a ring zone in the beam profile.

### BACKGROUND

An optical apparatus for laser beam welding is described in DE 102 61 422 A1.

By means of laser welding (also called laser beam welding) it is possible to manufacture workpieces with comparatively high welding speed (feed speed) and little thermal warpage.

A good quality of the weld seam should also be ensured during laser welding. During the welding process, undesired formation of spatter at the weld seam can occur; likewise, the weld seam produced may have undesired humping or undesired edge notches, and overall may not attain the desired mechanical strength. As a result, the productivity (welding speed) during laser welding is generally limited.

DE 102 61 422 A1 describes splitting a laser beam for laser welding between two partial beams, one of the partial beams leading the other partial beam in relation to the welding direction. In this case, a laser beam is collimated and split by means of a prism that is displaceable transversely with respect to the beam direction. One of the partial beams passes through a spot variation lens, and both partial beams pass through a focusing lens. Welds with improved quality are the to be achieved as a result.

Splitting a laser beam among a plurality of partial beams during laser welding has for example also been disclosed by DE 10 2015 112 537 A1, WO 2018/099851 A1, DE 10 2016 105 214 A1, DE 10 2017 208 979 A1 or US 2018/0185960 A1.

DE 10 2010 003 750 A1 describes setting the beam profile characteristic of a laser beam with a multiclad fiber. In this case, in particular, a first portion of an original laser beam can be coupled into a core fiber and a second portion into a ring fiber surrounding the core fiber.

Multiclad fibers have for example also been disclosed by US 2002/0172485 A1 or US 2006/0263024 A1.

WO 2016/205805 A1 describes systems for laser welding in which a plurality of laser fibers can be used for a plurality of laser beams, and wherein diffractive optical elements for beam shaping are proposed.

The inventors have recognized that if the laser welding is implemented as full penetration welding, such that the material of the workpiece to be welded melts as far as the underside of the workpiece, opposite the laser beam incidence side, then it is necessary to achieve a good quality of the weld seam with regard to both the top side and the underside of the workpiece, for instance with regard to spatter formation or humping.

### SUMMARY

In an embodiment, the present disclosure provides an optical apparatus that is for laser welding of a workpiece. The optical apparatus includes: a laser beam source configured to provide a laser beam; a collimation optical unit configured to collimate the provided laser beam of the laser beam source; a beam splitter device configured to split the collimated laser beam among a plurality of partial beams, the beam splitter device having a first setting facility, which is configured to variably set the splitting of the collimated laser beam among the plurality of partial beams; and a focusing optical unit configured to focus the partial beams onto the workpiece to be welded. The laser beam source has a multiclad fiber having a core fiber and at least one ring fiber and a second setting facility. The second setting facility is configured to variably split an input laser beam at a first fiber end of the multiclad fiber between the core fiber and the at least one ring fiber. A second fiber end of the multiclad fiber is configured to provide the laser beam for the collimation optical unit. The beam splitter device is configured to split the collimated laser beam among at least two leading partial beams, in relation to a welding direction provided, and a trailing partial beam. The leading partial beams are lined up transversely with respect to the welding direction provided. The first setting facility is configured to effect a setting of the energy distribution between the at least two leading partial beams and the trailing partial beam.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of one embodiment of an optical apparatus according to the invention;

FIG. 2 shows a schematic oblique view of a beam splitter device embodied as a wedge plate according to an embodiment of the invention;

FIG. 3 shows a schematic oblique view of a beam splitter device embodied as a diffractive optical element according to an embodiment of the invention and also a height diagram of the diffractive optical element;

FIG. 4 schematically shows a focus image of a first variant of a method according to an embodiment of the invention for the laser welding of a workpiece, wherein the two leading partial beams and the trailing partial beam do not overlap;

FIG. 5 schematically shows a focus image of a second variant of a method according to an embodiment of the invention for the laser welding of a workpiece, wherein the leading partial beams do not overlap one another, but overlap the trailing partial beam;

FIG. 6 schematically shows a focus image of a third variant of a method according to and embodiment of the invention for the laser welding of a workpiece, wherein the leading partial beams do not overlap one another, but overlap the trailing partial beam;

FIG. 7 shows a schematic diagram of the energy distribution in the beam profile of a leading partial beam according to an embodiment of the invention; and

FIG. 8 shows a schematic diagram of the profile of a refractive index of a multiclad fiber according to an embodiment of the invention along a cross section.

### DETAILED DESCRIPTION

Embodiments of the present invention enable good quality of weld seams in conjunction with relatively high feed speed, in particular for laser welding with full penetration welding.

An embodiment of the present invention provides an optical apparatus, which is characterized by the fact that the laser beam source comprises a multiclad fiber having a core fiber and at least one ring fiber and a second setting facility, wherein, by means of the second setting facility, an input laser beam at a first fiber end of the multiclad fiber is variably splitable between the core fiber and the at least one ring fiber, and wherein a second fiber end of the multiclad fiber provides the laser beam for the collimation optical unit, and wherein the beam splitter device is configured to split the collimated laser beam among at least two leading partial beams, in relation to a welding direction provided, and a trailing partial beam, wherein the leading partial beams are lined up transversely with respect to the welding direction provided, and wherein the first setting facility makes it possible to effect a setting of the energy distribution between the at least two leading partial beams, on the one hand, and the trailing partial beam, on the other hand.

According to an embodiment of the invention, the laser welding can be implemented with (at least) two leading (front) partial beams and a trailing (back) partial beam. In this case, the energy distribution between the leading partial beams and the trailing partial beam can be set in a targeted manner by means of the first setting facility. The use of the multiclad fiber makes it possible to obtain a beam profile on the workpiece to be welded with a core zone (from the core fiber) and at least one ring zone (from the at least one ring fiber) for the respectively partial beams. The energy distribution between the core zone and the ring zone can be set in a targeted manner by means of the second setting facility. These degrees of freedom make it possible to optimize the laser welding process, in particular for laser welding with full penetration welding of the workpiece or of the workpiece parts to be connected.

In the context of the invention, only one laser is required, which generates the input laser beam, this being particularly simple from a structural standpoint. With the optical apparatus, (at least) three copies of the laser beam profiled by the multiclad fiber can be obtained by means of the beam splitter device.

In the context of the invention, with the leading partial beams it is possible to implement partial penetration welding on the top side of the workpiece. In this case, the beam profile respectively established at the front partial beams by means of the multiclad fiber makes it possible to achieve a particularly good quality on the top side of the seam. In particular, the laser power of the leading partial beams can be distributed over a comparatively large area or width as a result of the leading partial beams being lined up transversely with respect to the feed direction (welding direction) and the beam profile. The full penetration welding can be implemented with the trailing partial beam. In this case, the preparation of the workpiece by means of the leading partial beams makes it possible to obtain a good seam quality on the underside of the workpiece as well.

In the context of the present invention, compared with laser welding with a simple leading partial beam and without the beam profile according to the invention being established, a higher feed speed can be achieved without the occurrence of relevant humping or relevant notch formation (in particular on the top side of the seam, but also on the underside) and without the occurrence of relevant spatter formation (in particular on the underside of the seam, but also on the top side).

Typically, the multiclad fiber is embodied as a 2 in 1 fiber, i.e. with a core fiber and exactly one ring fiber. Furthermore, the collimated laser beam is typically split among exactly two leading partial beams and a trailing partial beam.

The second setting facility can for example displace the input laser beam relative to the first fiber end transversely with respect to the beam propagation direction, or else alter a focusing of the input beam such that the width of the input beam varies at the first fiber end; in this respect, cf. DE 10 2010 003 750 A1.

The input laser beam is preferably generated by a solid-state laser.

In a preferred embodiment, an optical apparatus according to the invention provides that the beam splitter device forms a deflection zone for each partial beam, and wherein, by means of the first setting facility, the beam splitter device is movable in at least one setting direction transversely with respect to a beam propagation direction of the collimated laser beam, wherein the energy distribution between the partial beams can be set by way of the overlap of the collimated laser beam with the respective deflection zones. Such beam splitter devices are structurally simple and also simple in terms of handling. The deflection zones each deflect a partial area of the cross section of the collimated laser beam in a different direction than the other deflection zones (a deflection zone can accordingly allow the collimated laser beam to pass without being deflected).

One advantageous development of this embodiment provides for the deflection zones for the partial beams to be arranged around a common center, in particular wherein one deflection zone for the trailing partial beam occupies an angular interval of 180° around the common center, and two deflection zones for exactly two leading partial beams each occupy 90° around the common center, and the setting direction runs along a boundary of the two deflection zones for the two leading partial beams. With this design, in a simple manner, with regard to the leading partial beams, uniform splitting between two partial beams can be effected, and variable energy splitting can be effected at the same time between the totality of the leading partial beams, on the one hand, and the trailing partial beam, on the other hand. The collimated laser beam oriented toward the common center achieves a uniform distribution of the energy between the totality of the leading partial beams, on the one hand, and the trailing partial beam, on the other hand. The beam splitter device can be moved relative to the collimated laser beam along the direction of incidence toward the deflection zones for the leading partial beams in order to obtain an energy proportion of greater than 50% for the leading partial beams, or can be moved toward the deflection zone for the trailing partial beam in order to obtain an energy proportion of greater than 50% for the trailing partial beam.

Preference is given to an embodiment in which the beam splitter device is embodied with a refractive optical element, in particular wherein the beam splitter device forms a wedge plate having a plurality of deflection zones which form an inclination relative to a beam propagation direction of the collimated laser beam and which have a different orientation in relation to the beam propagation direction. Such a beam splitter device is simple in terms of construction and intuitive in terms of handling. It is noted that a deflection zone of a wedge plate can also be embodied without inclination with respect to the beam propagation direction, or the wedge plate does not cover a part of the cross section of the collimated x-ray beam in order to generate an undeflected partial beam.

In an alternative embodiment, the beam splitter device is embodied with a diffractive optical element, in particular wherein the beam splitter device has a plurality of diffraction zones forming sawtooth gratings, wherein the sawtooth gratings have a different orientation in relation to a beam propagation direction of the collimated laser beam and/or have a different construction. The diffractive optical element is simple to produce, and can be embodied comparatively compactly. The sawtooth grating is formed by a surface of the beam splitter device as a height profile (thickness profile). A diffraction zone can also be embodied without sawtooth gratings, or the beam splitter device may not cover a part of the cross section of the collimated x-ray beam in order to generate an undeflected partial beam. The diffraction zones (deflection zones) each deflect a partial area of the cross section of the collimated laser beam in a different direction than the other diffraction zones.

An embodiment of the present invention also includes a method for the laser welding of a workpiece, wherein a workpiece is welded by means of a plurality of partial beams along a welding direction, which method is characterized by the fact that the workpiece is welded with at least two leading partial beams, in relation to the welding direction, and a trailing partial beam, wherein the leading partial beams each have a beam profile with a core zone and at least one ring zone lying around the core zone, wherein the leading partial beams are lined up transversely with respect to the welding direction, and wherein, in the case of the leading partial beams, an integrated laser power in the respective core zone is greater than an integrated laser power in the respective at least one ring zone, and wherein the leading partial beams produce a partial penetration weld on the workpiece, and the trailing partial beam a full penetration weld.

The method according to the above embodiment of the invention makes it possible to weld a workpiece or the workpiece parts thereof with a high seam quality both on the top side of the workpiece and on the underside of the workpiece with a high feed speed (welding speed) with full penetration welding. In particular, humping and notch formation on the weld seam can be kept low (in particular on the top side, but also on the underside) and spatter formation can be kept low (in particular on the underside, but also on the top side).

In the context of the invention, in the case of a respective (leading) partial beam, a greater integrated laser power is allotted to the core zone than to the at least one ring zone. The limited power input in the ring zone is advantageous for the quality of the weld seam on the top side; in particular, the weld pool dynamics can become low as a result. The core zone makes it possible to ensure a sufficient welding depth, including in the context of the partial penetration welding at the leading partial beam.

The power distribution between the core zone and the at least one (typically exactly one) ring zone can be chosen specifically for a desired application. By way of example, in the case of a partial beam, the integrated laser power in a respective core zone is at least 60%, preferably at least 65%, particularly preferably at least 70%, and the integrated laser power in the respective at least one ring zone is a maximum of 40%, preferably a maximum of 35%, particularly preferably a maximum of 30%, in each case relative to the total incident laser power of the partial beam.

Typically, moreover, the energy distribution between the leading partial beams (VT) and the trailing partial beam (NT) is between 40% VT/60% NT and 60% VT/40% NT.

A workpiece to be welded (or two partial workpieces of the workpiece that are to be welded together) typically have a sheet metal thickness of 1 mm to 4 mm at the welding location.

The partial beams with the core zone and the ring zone generally have a two-stage top-hat radiation profile. In this case, the laser intensity within a respective ring zone is substantially homogenous, for example in a range of +/−20%, preferably +/−10%, around a mean value of the laser intensity in the ring zone; likewise, the laser intensity within a respective core zone is substantially homogeneous, for example in a range of +/−40%, preferably +/−20%, around a mean value of the laser intensity within the core zone (in this case, it is possible to disregard the transitions between core zone and ring zone and between ring zone and surroundings/optionally further ring zone in which the laser intensity varies “approximately” but which constitute only a small portion of the irradiated area, typically in each case less than 15%, preferably less than 10%, in comparison with the adjacent core zone or ring zone).

It is typically provided that a setting of an energy distribution between the leading partial beams, on the one hand, and the trailing partial beam, on the other hand, can be effected by means of a first setting facility, and that a setting of an energy distribution between the respective ring zones and the respective core zones can be effected by means of a second setting facility.

This can be utilized to alter the energy distributions during the welding process on a respective workpiece in order to optimize the welding during different stages of the welding process, for example in order that the welding during the piercing of the workpiece by the laser beam is implemented differently than the welding while traversing the weld seam. Likewise, it is possible to optimize the welding process during the welding of a respective workpiece by means of a control loop with the setting facilities, wherein the welding is monitored using a sensor; by way of example, it is possible to carry out adjustment toward a specific (average) melt pool size and/or toward a specific (for instance minimum) amplitude of a melt pool oscillation and/or a specific frequency of a melt pool oscillation.

Furthermore, workpieces of different workpiece types can be welded, wherein the first setting facility and the second setting facility are set differently depending on workpiece type. For this purpose, it is possible that, for a workpiece type to be welded, different energy distributions between the at least two leading partial beams and the trailing partial beam and also different energy distributions between the respective ring zones and the respective core zones are tried out in test welds and the quality of the welding obtained is assessed in each case, in particular with the inclusion of spatter formation during welding and humping and/or notch frequency of the weld seam obtained and taking account of top side and underside, and that a set of optimum energy distributions for the workpiece type is determined on the basis of the test welds, in particular wherein a multiplicity of workpieces of this workpiece type are then welded using the set of optimum energy distributions.

The method according to the invention can proceed in particular on an above-described optical apparatus according to the invention.

In one advantageous variant of the method according to the invention for the laser welding of a workpiece, it is provided that the trailing partial beam also has a beam profile with a core zone and at least one ring zone lying around the core zone. This makes it possible to generate the leading partial beams and the trailing partial beam in a simple manner from the same input laser beam, which is subjected to beam shaping for instance by means of a multiclad fiber. Moreover, the quality of the underside of the seam can also be advantageously influenced by this beam profile.

Preference is given to a further development of this variant, which provides that an input laser beam is fed into a first fiber end of a multiclad fiber having a core fiber and at least one ring fiber, as a result of which a laser beam is made available at a second fiber end of the multiclad fiber, a collimated laser beam being generated from the laser beam by means of a collimation optical unit, wherein the at least two leading partial beams and the trailing partial beam are generated from the collimated laser beam by means of a beam splitter device, and wherein the partial beams are focused onto the workpiece by means of a focusing optical unit. As a result, it is possible to generate the desired beam profile for the leading partial beam and also for the trailing partial beam with core zone and ring zone in a simple manner from only one input beam (and accordingly using only one laser).

In one advantageous variant, it is provided that on the workpiece the ring zones of the leading partial beams in each case overlap the ring zone of the trailing partial beam, but not the core zone of the trailing partial beam. Accordingly, the leading partial beams and the trailing partial beam overall form a continuous region illuminated by laser radiation on the workpiece. This reduces temperature gradients in the melt pool and thus reduces the melt pool dynamics.

In one preferred variant, it is provided that on the workpiece the ring zones of the leading partial beams overlap between the core zones in the direction transversely with respect to the welding direction. At least the leading partial beams then form a continuous region illuminated by laser radiation on the workpiece. Temperature gradients transversely with respect to the feed direction, in particular in the melt pool, can thereby be reduced, and the melt pool dynamics overall can be reduced.

In an advantageous further development of this variant, it is provided that the overlap of the ring zones of the leading partial beams is designed such that the ring zone of respectively the one leading partial beam substantially extends as far as the core zone of respectively the other leading partial beam, but does not overlap the core zone of respectively the other leading partial beam. This further reduces temperature gradients in the melt pool, and avoids in particular locally particularly high power inputs. The melt pool dynamics can be reduced further.

Preference is further given to a variant which provides that on the workpiece the following holds true for a diameter DK of a respective core zone and a diameter DR of a respective ring zone:
2*DK≤DR≤5*DK,
preferably 2.5*DK≤DR≤4.5*DK,
particularly preferably 3*DK≤DR≤4*DK. These size relationships have resulted in particularly good weld seam qualities. The laser energy can be distributed over a sufficient area in the ring zones, and at the same time sufficient welding depths can be achieved, for which the laser power in the core zones is of particular importance.

Preference is likewise given to a variant in which on the workpiece the following holds true for a diameter DK of a respective core zone and a diameter DR of a respective ring zone:
200 μm≤DK≤600 μm and 600 μm≤DR≤1800 μm, preferably
225 μm≤DK≤500 μm and 750 μm≤DR≤1500 μm, very particularly preferably
250 μm≤DK≤400 μm and 900 μm≤DR≤1500 μm. These size relationships have in turn resulted in particularly good weld seam qualities, in particular in the case of sheet metal thicknesses to be welded of 1 mm to 4 mm.

The scope of the present invention also includes the use of an above-described optical apparatus according to the invention in an above-described method according to the invention. As a result, laser welding with good weld seam quality and high productivity (feed speed) is possible, wherein the power distribution between the leading partial beams and the trailing partial beam and also between the at least one ring zone/ring fiber and the core zone/core fiber can be flexibly adapted in order to optimize the laser welding process.

Further advantages of the invention are evident from the description and the drawings. Likewise, according to the invention, the features mentioned above and those that will be explained still further can be used in each case individually by themselves or as a plurality in any desired combinations. The embodiments shown and described should not be understood as an exhaustive enumeration, but rather are of exemplary character for outlining the invention.

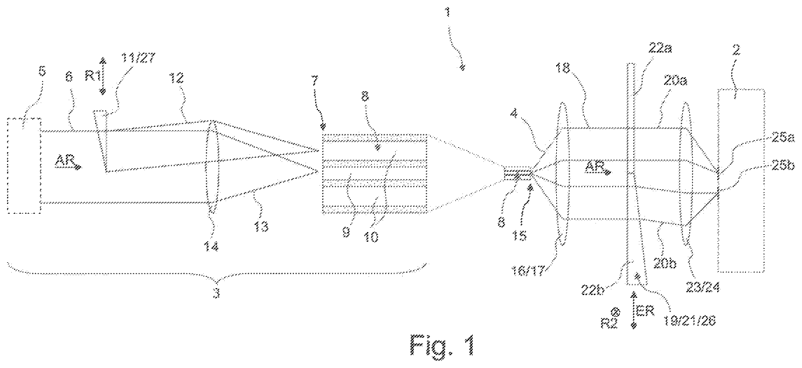

FIG. 1 shows, in a schematic illustration, by way of example, an optical apparatus 1 according to an embodiment of the invention for the laser welding of a workpiece 2. The left-hand part of the optical apparatus 1 in FIG. 1 is illustrated here in an enlarged view compared with the right-hand part of the apparatus 1, in order to afford a better understanding, and the enlargement transition lies in the region of the multiclad fiber 8 (cf. the dotted cone).

The optical apparatus 1 comprises a laser beam source 3 for providing a laser beam 4 having a particular beam profile, here with a core zone and a ring zone surrounding the latter.

For this purpose, the laser beam source 3 here comprises a solid-state laser 5, which makes available here a collimated input laser beam 6. The input laser beam 6 is coupled into a first (input-side) fiber end 7 of a multiclad fiber 8. The multiclad fiber 8 here has a core fiber 9 and a ring fiber 10 surrounding the latter; it is noted that one or a plurality of further ring fibers surrounding the ring fiber 10 can also be provided in other embodiments. A wedge 11 composed of a material which is transparent to the input laser beam 6 but refracts light projects here into the input laser beam 6. As a result, a portion 12 of the input laser beam 6 is deflected. The deflected portion 12 and an undeflected remaining portion 13 of the input laser beam 6 are focused onto the first fiber end 7 here by a focusing lens 14, the deflected portion 12 being coupled into the ring fiber 10 and the non-deflected, remaining portion 13 being coupled into the core fiber 9.

Over the length of the multiclad fiber 8 (which is illustrated in a shortened fashion in the schematic illustration) the laser power of the coupled-in portions 12, 13 of the input laser beam 6 is distributed (depending on the laser modes and the length of the multiclad fiber) substantially uniformly between the entire cross section of core fiber 9 and ring fiber 10. As a result, at a second (output-side) fiber end 15 of the multiclad fiber 8, the laser beam 4 is made available with a so-called two-stage top-hat beam profile (in this respect, also cf. further below).

The profiled laser beam 4 made available by the laser beam source 3 at the second fiber end 15 is then collimated (parallelized) by a collimation optical unit 16. The collimation optical unit 16 is embodied here with a collimation lens 17; in other embodiments, for example, a combination of two crossed cylindrical lens array can also be used. A beam splitter device 19 then splits the collimated laser beam 18 among at least three partial beams 20a, 20b, namely two leading partial beams and a trailing partial beam (not all of the partial beams are directly evident in FIG. 1; see more on that below). The beam splitter device 19 is embodied here as a wedge plate 21 having a plurality of deflection zones 22a, 22b embodied with different inclinations. The wedge plate 21 consists of material which is transparent to the laser beam 18 but refracts light. Accordingly, the partial beams 20a, 20b are deflected in (slightly) different directions. The partial beams 20a, 20b are then focused onto the workpiece 2 by a focusing optical unit 23, which here is embodied with a focusing lens 24. The beam spots 25a, 25b of the partial beams 25a, 25b are displaced (slightly) relative to one another as a result of the different deflections of the partial beams 20a, 20b at the beam splitter device 19. The beam spots 25a, 25b each have the beam profile impressed by the laser beam source 3 and in particular the multiclad fiber 8 there (in this respect, also cf. the focus images below).

The wedge plate 21 is movable by a mechanism, preferably motorized mechanism, not illustrated in more specific detail, along here a setting direction ER and a second direction R2 running perpendicularly to the plane of the drawing; the setting direction ER and the second direction R2 both run transversely with respect to the propagation direction AR of the collimated laser beam 18 and additionally perpendicularly to one another. The proportions (energy proportions) of the partial beams 20a, 20b that are obtained from the collimated laser beam 18 can be altered as a result. The wedge plate 21 or the beam splitter device 19 including the further mechanism is accordingly designated as a first setting facility 26, which makes it possible to set a power distribution between the partial beams 20a, 20b, and in this case in particular between the leading partial beams, on the one hand, and the trailing partial beams, on the other hand.

The wedge 11 is movable by a further mechanism, preferably motorized mechanism, along a first direction R1 running transversely with respect to the propagation direction AR of the input laser beam 6. The proportions (energy proportions) of the portions 12 and 13 of the input laser beam 6 can be altered as a result. The wedge 11 including the mechanism is accordingly designated as a second setting facility 27, which makes it possible to set a power distribution between the core fiber 9 (or the core zone of the beam profile) and the ring fiber 10 (or the ring zone of the beam profile).

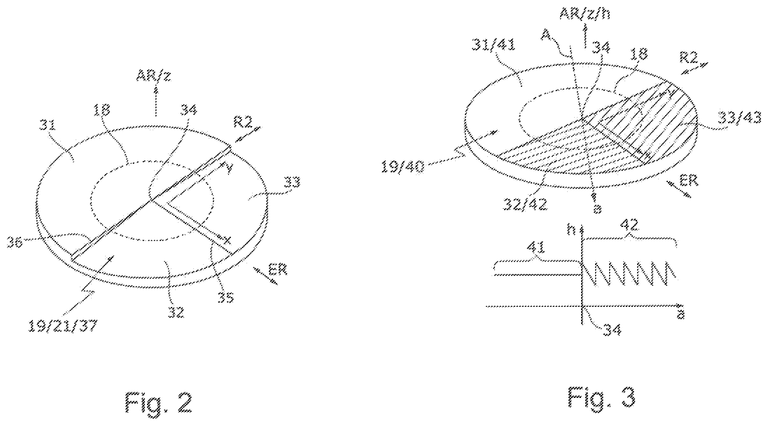

FIG. 2 schematically shows an exemplary wedge plate 21 which can be used in the context of an embodiment of the invention as a beam splitter device 19 for the collimated laser beam 18 (cf. the boundary line depicted in a dashed manner).

The wedge plate 21 here has three deflection zones 31, 32, 33 arranged around a center 34; the wedge plate 21 here is configured substantially in the shape of a circular disk. The underside of the wedge plate 21 here is embodied in planar fashion and perpendicularly to the propagation direction AR of the collimated laser beam 18. On the top side, however, the deflection zones 31, 32, 33 are embodied with a different inclination or orientation relative to the propagation direction AR.

The deflection zone 31 occupies an angular interval of 180° around the center 34. The deflection zone 31 is oriented with the top side perpendicular to the propagation direction AR/z-direction (i.e. “without” inclination). The portion of the collimated laser beam 18 which impinges on this deflection zone 31 is not deflected by the top side of the wedge plate 21 on account of approximately perpendicular impingement. This portion forms the trailing partial beam. It is noted that, according to the invention, the deflection zone 31 can also be embodied without material, i.e. the associated portion of the collimated laser beam 18 propagates past the wedge plate 21 (“half-element”), not illustrated in more specific detail.

The deflection zone 32 occupies an angular interval of 90° around the center 34. The top side of the deflection zone 32 is slightly inclined relative to the top side of the deflection zone 31 or relative to the plane perpendicular to the propagation direction AR (=z-direction) of the collimated laser beam 18, for example by −0.30° relative to the x-direction and −0.12° relative to the y-direction. The portion of the collimated laser beam 18 which impinges on the deflection zone 32 is deflected on account of this inclination. This portion forms a leading partial beam.

The deflection zone 33 likewise occupies an angular interval of 90° around the center 34. The top side of the deflection zone 33 is likewise slightly inclined relative to the top side of the deflection zone 31 or relative to the plane perpendicular to the propagation direction AR (=z-direction) of the collimated laser beam 18, but mirror-symmetrically with respect to the xz-plane in comparison with the deflection zone 32. The deflection zone 33 is inclined for example by +0.30° relative to the x-direction and −0.12° relative to the y-direction. The portion of the collimated laser beam 18 which impinges on the deflection zone 33 is deflected on account of this inclination. This portion forms a further leading partial beam.

In the relative position of the wedge plate 21 in relation to the collimated laser beam 18 as shown, in which position the collimated laser beam 18 is centered on the center 34 of the wedge plate 21, the two leading partial beams will each obtain a power proportion of 25% and the trailing partial beam will obtain a power proportion of 50% of the total laser power.

In order to alter these power proportions, the wedge plate 21 can be moved from the centered position shown at least along the extension direction ER running along the boundary 35 of the two deflection zones 32, 33. The extension direction ER runs parallel to the x-direction. By moving the wedge plate 21 (relative to the laser beam 18) in the positive x-direction, it is possible to increase the power proportion of the trailing partial beam and to reduce the power proportions of the leading partial beams, and vice versa.

Preferably, the wedge plate 21 can furthermore be moved from the position shown (and independently of the displacement along the extension direction ER) additionally in the second direction R2, which runs along a boundary 36 between the deflection zone 31 and the deflection zones 32, 33. The second direction R2 runs parallel to the y-direction. By moving the wedge plate 21 (relative to the laser beam 18) in the positive y-direction, it is possible to increase the power proportion of the leading partial beam of the deflection zone 32 and to reduce the power proportion of the leading partial beam of the deflection zone 33, and vice versa; in this case, the power proportion of the trailing partial beam remains unchanged.

The different deflection effects of the deflection zones 31, 32, 33 of the wedge plate 21 are based on light refraction, and the wedge plate 21 is accordingly regarded as a refractive optical element 37.

Alternatively, it is also possible to embody a beam splitter device 19 with a diffractive optical element 40; in this respect, cf. the schematic, exemplary illustration in FIG. 3. The diffractive optical element 40 is fabricated from a material which is transparent to the laser beam 18 but refracts light; it in turn has a planar underside lying perpendicular to the propagation direction AR. The diffractive optical element 40 likewise forms deflection zones 31, 32, 33 that generate from the collimated laser beam 18 partial beams directed in different directions. However, the different deflection effects of the deflection zones 31, 32, 33 are substantially based on a diffraction of the collimated laser beam 18, for which reason the deflection zones 31, 32, 33 are also referred to as diffraction zones 41, 42, 43.

In the embodiment shown, the laser beam 18 is not deflected in the diffraction zone 41 since there the diffractive optical element 40 is embodied in a planar fashion (with a constant local height h, i.e. without a sawtooth grating) on its top side. It is noted that, according to and embodiment of the invention, the diffraction zone 41 can also be embodied without material, i.e. the associated portion of the collimated laser beam 18 propagates past the diffractive optical element 40 (“half-element”).

In the diffraction zone 42, by contrast, on the top side there is established a sawtooth grating with a locally variable height (or locally variable thickness of the diffractive optical element 40 in the beam propagation direction AR) of the diffractive optical element 40; cf. the height profile at the bottom, in which the local height h (in the z-direction) is plotted against the location along the sectional direction a (cf. the dashed sectional plane A). In the case of the diffractive optical element 40, in the diffraction zone 42 lines are used to indicate where the local height h is in each case identical and maximal. The lines are slightly inclined (here by approximately +15°), relative to the y-direction, thus resulting in a corresponding slight deflection of the laser beam 18 in the region of the diffraction zone 42. The lines run perpendicularly to the sectional direction a depicted, and the sawtooth profile repeatedly falls along this sectional line and repeatedly rises abruptly.

The diffraction zone 43 analogously likewise has a sawtooth profile. The latter, with its lines indicating the local height, which is in each case identical and maximal, is inclined relative to the y-direction diametrically oppositely to the diffraction zone 42, here with its lines by approximately −15° relative to the y-direction, as a result of which a corresponding diametrically opposite slight deflection of the laser beam 18 is produced there.

For the rest, the functioning of the beam splitter device 19 from FIG. 3 is analogous to the beam splitter device from FIG. 2.

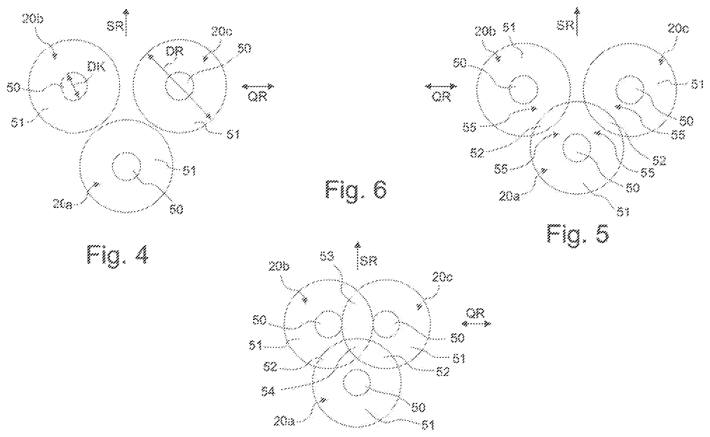

FIGS. 4 to 6 schematically illustrate exemplary focus images which can be employed in the context of the invention. The focus images show the partial beams 20a-20c which are directed onto the top side of the workpiece during the laser beam welding and, by means of the focusing optical unit, are focused onto the workpiece or the surface thereof, at the location of the surface corresponding to the plane of the drawing.

In the variants shown, in each case in relation to a predefined relative welding direction (feed direction) SR, two leading partial beams 20b, 20c and a trailing partial beam 20a are used. The leading partial beams 20b, 20c here are arranged in a manner lined up in a straight line in relation to a transverse direction QR; the transverse direction QR runs perpendicularly to the welding direction SR.

All the partial beams 20a, 20b, 20c are typically generated from the same input laser beam, which has obtained a particular beam profile as a result of passing through a multiclad fiber; all the partial beams 20a, 20b, 20c then accordingly also have the beam profile. The beam profile comprises in each case a core zone 50, within which a substantially constant power density LDK (“intensity”) of laser radiation is present, and a ring zone 51, in which likewise a substantially constant power density LDR of laser radiation is present; further ring zones can also be provided in other variants.

The partial beams 20a, 20b, 20c basically pass through the same optical elements (in particular the focusing optical unit) downstream of the beam splitter arrangement, such that the partial beams 20a, 20b, 20c have an identical size on the workpiece. The diameters DK of the core zone 50 and DR of the ring zone 51 can be measured on the workpiece (or on the top side of the workpiece). DK is usually between 200 μm and 600 μm, often around 300 μm. Furthermore, DR is usually between 600 μm and 1800 μm, often around 700 μm.

By means of a first setting facility (cf. FIG. 1), for all the partial beams 20a-20c laser power can be redistributed in each case between the core zone 50 and the ring zone 51; the laser power ILK integrated over the area of the core zone 50 (“integrated intensity”) here is greater than the laser power ILR, integrated over the area of the ring zone 51; it usually holds true that ILK:ILR≥60:40 or even ILK:ILR≥70:30. For the ratio DR/DK, it usually holds true that 2≤DR/DK≤5, usually where 3≤DR/DK≤4.

By means of the second setting facility (cf. FIG. 1), laser power can be redistributed between the totality of the leading partial beams 20b, 20c, on the one hand, and the trailing partial beam 20a, on the other hand; the laser power VT integrated over the area of all the leading partial beams 20b, 20c and the laser power NT integrated over the area of the trailing partial beam 20a are typically approximately equal in magnitude; it usually holds true that VT:NT≤60:40 and VT:NT≥40:60.

With the leading partial beams 20b, 20c, the workpiece is melted from the top side, wherein the melt pool region produced by the leading partial beams 20b, 20c does not extend as far as the underside of the workpiece (“partial penetration welding”). The trailing partial beam produces a melt pool region that extends as far as the underside of the workpiece (“full penetration welding”). The combination of the leading partial beams 20b, 20c with the trailing partial beam 20a makes it possible to obtain a weld seam which is of particularly high quality and in particular has high mechanical strength, little humping and few notches in conjunction with only little spatter formation during the welding process on the top side and the underside of the workpiece. In this case, the welding process can be optimized by way of the setting of the power distribution.

FIG. 4 shows a variant in which the two leading partial beams 20b, 20c do not overlap one another, and furthermore the leading partial beams 20b, 20c also do not overlap the trailing partial beam 20a. It is noted, however, that here in the welding direction SR the ring zone 51 of the trailing partial beam 20a, in relation to the welding direction SR, reaches as far as between the ring zones 51 of the leading partial beams 20b, 20c.

The addition of laser power of different partial beams is avoided in the case of this variant. This can help to keep the melt pool dynamics low, and in particular to avoid spatter formation primarily on the top side of the workpiece. This variant is often preferred in the case of relatively small workpiece thicknesses, for example a workpiece thickness of between 1 mm and 2.5 mm.

FIG. 5 shows a variant in which the leading partial beams 20b, 20c once again do not overlap. Here, however, in the overlap zones 52, the leading partial beams 20b, 20c overlap the trailing partial beam 20a in the region of the ring zones 51; however, the centers of the partial beams 20a, 20b and 20a, 20c are so far apart from one another that residual regions 55 of non-overlapped ring zone 51 still remain in each case between the overlap zone 52 and the two core zones 50 of the partial beams 20a, 20b and 20a, 20c.

In this variant, a continuous area illuminated by laser radiation is formed by the totality of the partial beams. This can contribute to reducing temperature gradients in the melt pool, and to reducing humping of the weld seam obtained or else notch formation. This variant is often preferred in the case of medium workpiece thicknesses, for example a workpiece thickness of between 2.5 mm and 3.2 mm.

FIG. 6 shows a variant in which the leading partial beams 20b, 20c overlap in the transverse direction QR in the region of the ring zones 51, but not in relation to the core zones 50, cf. the overlap zone 53. In the variant shown, however, the overlap zone 53 extends in each case as far as to touch the core zones 50. Furthermore, the leading partial beams 20b, 20c overlap the trailing partial beam 20a in the region of the ring zones 51. Overlap zones 52 of the partial beams 20a, 20b and 20a, 20c are obtained as a result, which overlap zones however here do not extend as far as the core zones 51; moreover, in the overlap zone 54 here there is an overlap of the ring zones 51 of all three partial beams 20a, 20b, 20c.

In this variant, as a result of addition of the laser power of two partial beams over comparatively large areas and even of three partial beams in the overlap region 54, it is possible to achieve a locally increased power density of the laser radiation. As a result, it is possible to achieve a greater penetration into the workpiece, in particular in the overlap region of the two leading partial beams. As a result, full penetration welding with the trailing partial beam is facilitated and in particular becomes accessible even in the case of relatively high welding speeds and/or a relatively large workpiece thickness. This variant is often preferred in the case of relatively large workpiece thicknesses, for example a workpiece thickness of between 3.2 mm and 4 mm.

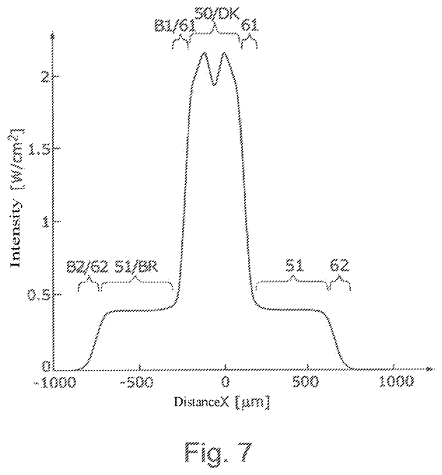

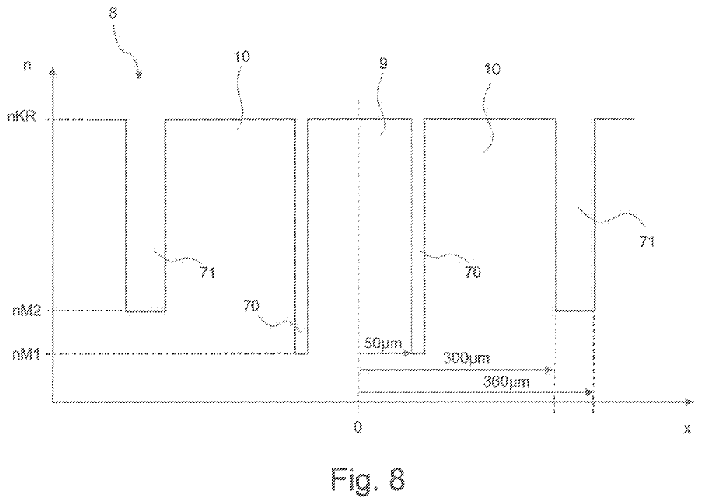

FIG. 7 illustrates, by way of example, the intensity profile 60 of a leading partial beam which can be employed in the context of a method according to an embodiment of the invention on a workpiece. A corresponding intensity profile is generally also afforded for the trailing partial beam on the workpiece. The intensity I (laser power per area) is plotted on the ordinate axis as a function of the location x, wherein the x-axis runs through the center of the laser beam (at x=0).

The intensity profile 60 here is a two-stage top-hat radiation profile; it can be produced by the use of a double-clad fiber (in this respect, see FIG. 8).

The intensity profile 60 has a core zone 50, within which a high, substantially constant intensity I1 of here approximately 2.1 W/cm² is present; the intensity in the core zone 50 typically fluctuates by a maximum of 40%, preferably a maximum of 20%, around the average intensity of the core zone 50. The core zone 50 is surrounded by a ring zone 51, within which a lower, likewise substantially constant intensity 12 of here approximately 0.4 W/cm² is present; the intensity in the ring zone 51 typically fluctuates by a maximum of 20% around the average intensity of the ring zone 51. The intensity falls sharply in a transition region 61 from the core zone 50 to the ring zone 51; in this case, the intensity there can even fall below 12. The intensity likewise falls sharply in a further transition region 62 from the ring zone 51 to the outer surroundings, here (in the absence of a further core zone) down to zero. The transition regions 61, 62 typically constitute only small widths B1, B2 in comparison with the diameter DK of the core zone 50 or with the width BR of the ring zone 51, for example where B1≤0.3*DK or B1≤0.2*DK, or where B2≤0.3*BR or B2≤0.2*BR.

FIG. 8 illustrates, in a schematic diagram, by way of example the construction of a multiclad fiber 8 in the region of core fiber 9 and ring fiber 10 (“double-clad fiber” or 2 in 1 fiber) according to an embodiment of the invention. A multiclad fiber having even more ring fibers can alternatively be used as well. The location x in the cross section of the multiclad fiber 8 is plotted on the abscissa axis, and the refractive index n (for the wavelength used by the laser) is plotted on the ordinate axis; the center of the multiclad fiber 8 is situated at x=0.

An optical waveguide material having a high, here uniform refractive index nKR is arranged within the core fiber 9 and within the ring fiber 10. A first cladding 70 composed of a first cladding material having a refractive index nM1 is arranged between the core fiber 9 and the ring fiber 10. In this case, nM1 is significantly less than nKR; as a result, a total internal reflection of the laser radiation coupled into the core fiber 9 and the ring fiber 10 is achieved at the first cladding 70. A second cladding 71 composed of a second cladding material having a refractive index nM2 is arranged around the ring fiber 10. In this case, nM2 is in turn significantly less than nKR in order to bring about a total internal reflection of the laser radiation at the second cladding 71 as well. In the variant shown, moreover, nM1 is somewhat lower than nM2.

In the exemplary embodiment shown, the (external) radius of the core fiber 9 is approximately 50 μm, and the external radius of the ring fiber 10 is approximately 300 μm.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Optical apparatus

2 Workpiece

3 Laser beam source

4 Laser beam (provided by the laser beam source)

5 Laser

6 Input laser beam (provided by the laser)

7 First fiber end

8 Multiclad fiber

9 Core fiber

10 Ring fiber

11 Wedge

12 Deflected portion (of the input laser beam)

13 Undeflected portion (of the input laser beam)

14 Focusing lens

15 Second fiber end

16 Collimation optical unit

17 Collimation lens

18 Collimated laser beam

19 Beam splitter device

20a (Trailing) partial beam

20b (Leading) partial beam

20c (Leading) partial beam

21 Wedge plate

22a Deflection zone

22b Deflection zone

23 Focusing optical unit

24 Focusing lens

25a Beam spot

25b Beam spot

26 First setting facility

27 Second setting facility

31 Deflection zone (trailing partial beam)

32 Deflection zone (leading partial beam)

33 Deflection zone (leading partial beam)

34 Center (beam splitter device)

35 Boundary

36 Boundary

37 Refractive optical element

40 Diffractive optical element

41 Diffraction zone (trailing partial beam)

42 Diffraction zone (leading partial beam)

43 Diffraction zone (leading partial beam)

50 Core zone

51 Ring zone

52 Overlap zone (leading/trailing partial beam)

53 Overlap zone (leading/leading partial beam)

54 Overlap zone (three partial beams)

55 Residual region (of the ring zone without overlap)

60 Intensity profile

61 Transition region

62 Transition region

70 First cladding

71 Second cladding

A Sectional plane

a Sectional direction (in the diffractive optical element)

AR Propagation direction/beam propagation direction

DK Diameter of core zone

DR Diameter of ring zone

ER Setting direction

h Local height

I Intensity

ILK Integrated laser power of core zone

ILR Integrated laser power of ring zone

n Refractive index

QR Transverse direction

R1 First direction

R2 Second direction

SR Welding direction

x, y, z Spatial coordinates

1. An optical apparatus for laser welding of a workpiece, the optical apparatus comprising:
a laser beam source configured to provide a laser beam;
a collimation optical unit configured to collimate the provided laser beam of the laser beam source;
a beam splitter device configured to split the collimated laser beam among a plurality of partial beams, the beam splitter device having a first setting facility, which is configured to variably set the splitting of the collimated laser beam among the plurality of partial beams; and
a focusing optical unit configured to focus the partial beams onto the workpiece to be welded,
wherein the laser beam source comprises a multiclad fiber comprising a core fiber and at least one ring fiber and a second setting facility, wherein, the second setting facility is configured to variably split an input laser beam at a first fiber end of the multiclad fiber between the core fiber and the at least one ring fiber, and wherein a second fiber end of the multiclad fiber is configured to provide the laser beam for the collimation optical unit,
wherein the beam splitter device is configured to split the collimated laser beam among at least two leading partial beams, in relation to a welding direction provided, and a trailing partial beam, wherein the leading partial beams are lined up transversely with respect to the welding direction provided, and
wherein the first setting facility is configured to effect a setting of the energy distribution between the at least two leading partial beams and the trailing partial beam.

2. The optical apparatus as claimed in claim 1,
wherein the beam splitter device is configured to form a deflection zone for each partial beam,
wherein the first setting facility is configured to move the beam splitter device in at least one setting direction transversely with respect to a beam propagation direction of the collimated laser beam, and
wherein the energy distribution between the partial beams is configured to be set by way of the overlap of the collimated laser beam with the respective deflection zones.

3. The optical apparatus as claimed in claim 2,
wherein the deflection zones for the partial beams are arranged around a common center, and
wherein one deflection zone for the trailing partial beam occupies an angular interval of 180° around the common center, and two deflection zones for exactly two leading partial beams each occupy 90° around the common center, and the setting direction runs along a boundary of the two deflection zones for the two leading partial beams.

4. The optical apparatus as claimed in claim 1, wherein the beam splitter device comprises a refractive optical element, and
wherein the beam splitter device forms a wedge plate having a plurality of deflection zones which form an inclination relative to a beam propagation direction of the collimated laser beam and which have a different orientation in relation to the beam propagation direction.

5. The optical apparatus as claimed in claim 1, wherein the beam splitter device is comprises a diffractive optical element, and
wherein the beam splitter device has a plurality of diffraction zones forming sawtooth gratings, wherein the sawtooth gratings have a different orientation in relation to a beam propagation direction of the collimated laser beam or have a different construction.

6. A method for laser welding of a workpiece, the method comprising:
providing a laser beam;
collimating the provided laser beam;
splitting the collimated laser beam among a plurality of partial beams, the partial beams comprising at least two leading partial beams and a trailing partial beam;
focusing the partial beams on the workpiece such that the workpieces is welded with the plurality of partial beams along a welding direction,
wherein the workpiece is welded with the at least two leading partial beams, in relation to the welding direction, and the trailing partial beam,
wherein the leading partial beams each have a beam profile with a core zone and at least one ring zone lying around the core zone,
wherein the leading partial beams are lined up transversely with respect to the welding direction,
wherein, in the case of the leading partial beams, an integrated laser power in the respective core zone is greater than an integrated laser power in the respective at least one ring zone, and
wherein the leading partial beams produce a partial penetration weld on the workpiece, and the trailing partial beam produces a full penetration weld.

7. The method as claimed in claim 6, wherein the trailing partial beam has a beam profile with a core zone and at least one ring zone lying around the core zone.

8. The method as claimed in claim 7, the method comprising:
feeding an input laser beam into a first fiber end of a multiclad fiber having a core fiber and at least one ring fiber, as a result of which a laser beam is made available at a second fiber end of the multiclad fiber, a collimated laser beam being generated from the laser beam by a collimation optical unit,
wherein the at least two leading partial beams and the trailing partial beam are generated from the collimated laser beam by a beam splitter device, and
wherein the partial beams are focused onto the workpiece by a focusing optical unit.

9. The method as claimed in claim 7, wherein on the workpiece, the ring zones of the leading partial beams in each case overlap the ring zone of the trailing partial beam, but not the core zone of the trailing partial beam.

10. The method as claimed in claim 6, wherein on the workpiece, the ring zones of the leading partial beams overlap between the core zones in the direction transversely with respect to the welding direction.

11. The method as claimed in claim 10, wherein the overlap of the ring zones of the leading partial beams is such that the ring zone of respectively the one leading partial beam substantially extends as far as the core zone of respectively the other leading partial beam, but does not overlap the core zone of respectively the other leading partial beam.

12. The method as claimed in claim 6, wherein on the workpiece, the following holds true for a diameter DK of a respective core zone and a diameter DR of a respective ring zone:
2*DK≤DR≤5*DK,
preferably 2.5*DK≤DR≤4.5*DK,
particularly preferably 3*DK≤DR≤4*DK.

13. The method as claimed in claim 6, wherein on the workpiece the following holds true for a diameter DK of a respective core zone and a diameter DR of a respective ring zone:
200 μm≤DK≤600 μm and 600 μm≤DR≤1800 μm, preferably
225 μm≤DK≤500 μm and 750 μm≤DR≤1500 μm, very particularly preferably
250 μm≤DK≤400 μm and 900 μm≤DR≤1500 μm.

14. A method of operating an optical apparatus for laser welding of a workpiece, the optical apparatus comprising: a laser beam source; a collimation optical unit; a beam splitter device comprising a first setting facility; and a focusing optical unit, the laser beam source comprising a multiclad fiber comprising a core fiber and at least one ring fiber and a second setting facility, the method comprising:
splitting, using the second setting facility, an input laser beam received at a first fiber end of the multiclad fiber between the core fiber and the at least one ring fiber, such that a laser beam is provided, via a second fiber end of the multiclad fiber of the laser beam source, to the collimation optical unit;
collimating, using the collimation optical unit, the provided laser beam of the laser beam source;
splitting, using the beam splitter device, the collimated laser beam among at least two plurality of partial beams, the splitting comprising using the first setting facility of the beam splitter device, which is configured to variably set the splitting of the collimated laser beam among the plurality of partial beams; and
focusing, using the focusing optical unit, the partial beams onto the workpiece to be welded,
wherein the beam splitter device splits the collimated laser beam among at least two leading partial beams, in relation to a welding direction provided, and a trailing partial beam, wherein the leading partial beams are lined up transversely with respect to the welding direction provided, and
wherein the first setting facility is configured to effect a setting of the energy distribution between the at least two leading partial beams and the trailing partial beam.
